(19) United States
(12) Patent Application Publication
(10) Pub. No.: US 2007/0022304 A1
(43) Pub. Date: Jan. 25, 2007

(54) Monitoring apparatus

(76) Inventor: Yukiko Yanagawa, Nara-shi (JP)

Correspondence Address: DICKSTEIN SHAPIRO LLP, 1825 EYE STREET NW, Washington, DC, 20006-5403, US

(21) Appl. No.: 11/489,550

(22) Filed: Jul. 20, 2006

(30) Foreign Application Priority Data
Jul. 21, 2005 (JP) 2005-211437
May 26, 2006 (JP) 2006-146507

(51) Int. Cl. H04K 1/00; H04L 9/00

(52) U.S. Cl. 713/186

(57) ABSTRACT

An operator of a monitored instrument is authenticated and a maintenance function for the monitored instrument is released. The head of the authenticated operator is then tracked in a dynamic image and the maintenance function for the monitored instrument is operated when the tracking fails.

### RELATED APPLICATIONS

This application claims priority to Japanese Patent Application Nos. 211437/2005, filed Jul. 21, 2005 and 146507/2006, filed May 26, 2006.

### BACKGROUND OF THE RELATED ART

1. Field of the Invention

The present invention relates to an effective technique applied to an apparatus and a method for performing an authentication process to achieve information or apparatus security.

2. Description of the Related Art

Recently, the management of access to electronic information in an information processing apparatus is attracting attention because of problems with customer information leakage by companies and the implementation of the personal information protection law. For an access management method, generally an authentication process is performed with a password or biometric information at the time of logon to the information processing apparatus.

However, in the conventional access management method, once the logon is performed, it is not determined whether or not a person who operates the information processing apparatus is qualified. Therefore, it is not possible to prevent improper operation of the information processing apparatus by shifting the authenticated person to another person in the course of the operation.

In order to solve the above problem, there is proposed a technique of intermittently performing the authentication process even after the logon is performed (see Japanese Patent Application Laid-Open No. 2002-55956).

However, in this technique, there is a problem that improper operation cannot be prevented between an authentication process and a next authentication process. FIG. 5 specifically shows the problem in the conventional technique. As shown in FIG. 5, when the operator is shifted to another person, improper operation cannot be prevented until the next authentication process is performed.

When an interval of the authentication processes is shortened (for example, one-second interval), improper operation by shifting can be prevented. However, sometimes the authentication cannot be performed for the operator who is permitted through authentication, for example, because the operator bends his or her head to look at a document. In such a case, an error may be generated wherein it is necessary for authentication to be performed again.

### SUMMARY

In one aspect of the invention a convenient apparatus and method for suppressing improper operation and the like of an instrument by shifting an authenticated user to another user in operating an instrument such as an information processing apparatus.

A monitoring apparatus according to one embodiment of the present invention includes an authentication device which authenticates an operator of a monitored instrument; a tracking device which tracks a head of the operator authenticated by the authentication device in a dynamic image in which the head of the operator of the monitored instrument is taken; and a maintenance function control device which releases a maintenance function for the monitored instrument when the authentication device authenticates, and operates the maintenance function for the monitored instrument when the tracking device fails to track. The monitored instrument is a target instrument to be processed by the maintenance function which is controlled by the monitoring apparatus. The maintenance function enables for example management of access to the monitored instrument, access to predetermined data through the monitored instrument, or privacy of the operator. The head is defined as a portion of the body above the neck and includes the face.

The maintenance function control device can be configured to operate the maintenance function only when tracking is failed once. This configuration has the highest reliability. However, sometimes tracking fails although the tracking target exists in the dynamic image, when accuracy of the tracking process is low or quality of the dynamic image is poor. The operation possibly becomes troublesome if the maintenance function control device operates the maintenance function every time tracking is failed. Therefore, in an embodiment the maintenance function control device can be configured to operate the maintenance function when tracking is continuously failed in a predetermined number or more of frames or for a predetermined period or more of time. That is, even if tracking is failed, the maintenance function control device does not immediately operate the maintenance function, but the tracking device tries to return to (resume) tracking for the predetermined margin. Operability is improved by providing such margin.

According to another embodiment the invention, even after a user is authenticated and the maintenance function is released, the tracking device continuously performs the tracking process, and the maintenance function is operated when tracking is failed. The case where tracking is failed shall mean the case where the head of the authenticated operator cannot be tracked in the dynamic image in which the head of the operator of the monitored instrument is taken, namely, the case where the authenticated operator does not operate the monitored instrument.

The monitoring apparatus in an embodiment of the present invention can be configured such that the authentication device detects a face in the dynamic image to authenticate the operator by using an image of the detected face, and the tracking device tracks the head as a target of the process by the authentication device. Such a configuration improves usability, because the user is not required to input the password or insert a card for authentication. Further, the tracking device can be suppressed from tracking a wrong head (namely, a head of a person different from the person authenticated by the authentication device).

One or several embodiments can be implemented as a program which causes the information processing apparatus to execute processes performed by the respective devices as described above, or a recording medium in which the program is recorded. Further, the one or several embodiments can be implemented by a method in which the information processing apparatus executes the processes performed by the respective devices.

According to another embodiment of the present invention, improper operation of the instrument by shifting the authenticated user to another user can be suppressed in operating the instrument such as an information processing apparatus.

### BRIEF DESCRIPTION OF THE DRAWINGS

FIG. 1 shows an example of a monitored instrument;

FIG. 2 shows a functional block example of the monitoring apparatus;

FIG. 3 shows an example of a user information table;

FIG. 4 shows a flowchart of an operational example of a monitoring apparatus; and

FIG. 5 shows one of the problems in a conventional technique.

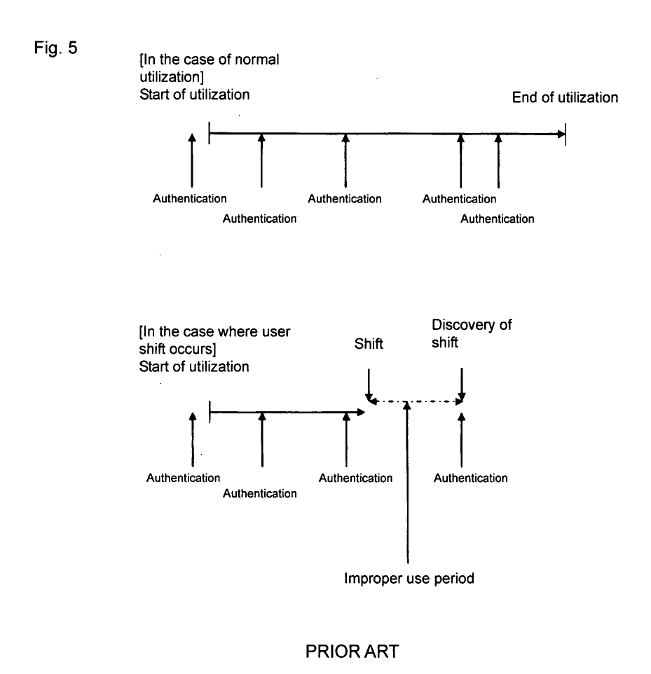

### DETAILED DESCRIPTION

A monitoring apparatus performs the authentication process and the like on a person who operates an instrument (hereinafter referred to as “monitored instrument”) who becomes a monitoring target, and controls the operation of the maintenance function based on the result of the authentication process. The operation of the maintenance function can realize access management (access permission or restriction) to the monitored instrument, access management to predetermined data through the monitored instrument, and privacy management of the operator. Any already-existing authentication technique such as fingerprint authentication or password authentication may be applied to the authentication process performed by the monitoring apparatus. The monitoring apparatus to which a face authentication process is applied will specifically be described below.

Monitored Instrument

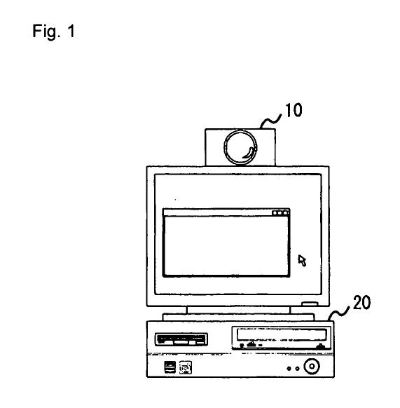

A specific example of the monitored instrument will be described. FIG. 1 shows an example of the monitored instrument. In FIG. 1, a personal computer 20 is shown as an example of the monitored instrument. A camera 10 to monitor a user is arranged at an upper portion of a display connected to the personal computer 20. By being connected to the personal computer 20 and the camera 10 through a network, the monitoring apparatus 1 may be installed away from the personal computer 20. Alternatively, the monitoring apparatus 1 may be installed at the same place as the personal computer 20 and camera 10 while connected to the same with a cable. The monitoring apparatus 1 may be configured to operate by executing a program with the personal computer 20, or by being configured as hardware and mounted on the personal computer 20. In this case, the camera 10 is connected to the personal computer 20. Although the personal computer is shown as a specific example of the monitored instrument in FIG. 1, another information processing apparatus such as PDA (Personal Digital Assistant) or a portable telephone may be used as the monitored instrument.

System Configuration

A configuration of the monitoring apparatus 1 will now be described. In hardware terms, the monitoring apparatus 1 includes a CPU (Central Processing Unit), a main storage unit (RAM), and an auxiliary storage unit and the like, which are connected through a bus. The auxiliary storage unit is formed with a non-volatile storage unit. As used herein, the non-volatile storage unit shall mean so-called ROM (Read-Only Memory: including EPROM (Erasable Programmable Read-Only Memory), EEPROM (Electrically Erasable Programmable Read-Only Memory), and mask ROM), FeRAM (Ferroelectric RAM), a hard disk drive, and the like.

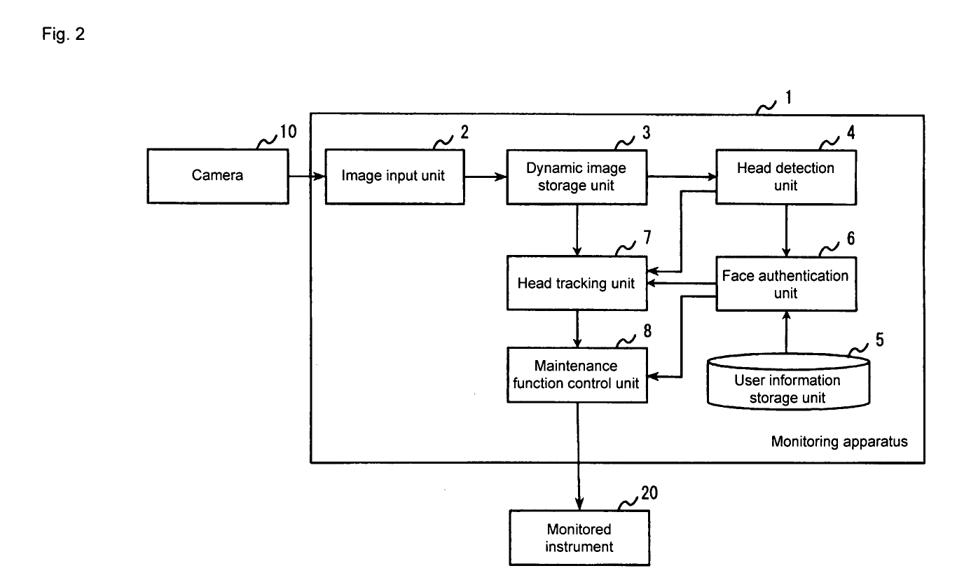

FIG. 2 shows a functional block diagram of the monitoring apparatus 1. Various programs (OS, applications, and the like) stored in the auxiliary storage unit are loaded on the main storage device and executed by CPU, and thereby the monitoring apparatus 1 functions as an apparatus including an image input unit 2, a dynamic image storage unit 3, a head detection unit 4, a user information storage unit 5, a face authentication unit 6, a head tracking unit 7, and a maintenance function control unit 8 and the like. The head detection unit 4, the face authentication unit 6, the head tracking unit 7, and the maintenance function control unit 8 are realized by executing the program by CPU. The head detection unit 4, the face authentication unit 6, the head tracking unit 7, and the maintenance function control unit 8 may be configured as a dedicated chip.

The respective functional units included in the monitoring apparatus 1 will now be described. The image input unit 2 functions as an interface to input dynamic image data to the monitoring apparatus 1. The image input unit 2 inputs the dynamic image data to the monitoring apparatus 1. The dynamic image inputted by the image input unit 2 is a dynamic image of a person operating the monitored instrument.

The image input unit 2 may be configured using any already-existing technique of inputting the dynamic image data to the monitoring apparatus 1. For example, the dynamic image data taken at a place away from the monitoring apparatus 1 may be inputted to the monitoring apparatus 1 through a network (such as local area network or internet). In this case, the image input unit 2 is formed using the network interface. The dynamic image data may be inputted to the monitoring apparatus 1 from the imaging device such as a digital video camera connected to the monitoring apparatus 1. In this case, the image input unit 2 is formed pursuant to a standard in which the digital video camera and the monitoring apparatus 1 are connected to each other such that data communication can be conducted. Examples of the standard include wired connection such as USB (Universal Serial Bus) and wireless connection such as Bluetooth (registered trademark). The monitoring apparatus 1 may include an imaging device such as a digital video camera or may be incorporated into various apparatuses (such as PDA and a portable telephone) including an imaging device such as a digital camera to input the dynamic image taken by the imaging device to the monitoring apparatus 1. In this case, the image input unit 2 may be formed as the interface for inputting the dynamic image data taken by the image pickup element such as a CCD (Charge-Coupled Devices) sensor or a CMOS (Complementary Metal-Oxide Semiconductor) sensor. The image input unit 2 may be configured to be able to correspond to the above plural cases.

Dynamic Image Storage Unit

The dynamic image storage unit 3 is formed with a storage unit. Any specific technique such as a volatile storage device and a non-volatile storage device may be applied to the storage unit used for the dynamic image storage unit 3. As used herein, the volatile storage unit shall mean so-called RAM (Random Access Memory: such as DRAM (Dynamic RAM), SDRAM (Synchronous DRAM), and DDR SDRAM (Double Data Rate SDRRAM)).

The dynamic image data inputted through the image input unit 2 is stored in the dynamic image storage unit 3. The dynamic image data stored in the dynamic image storage unit 3 is read by the head detection unit 4 or the head tracking unit 7. The dynamic image storage unit 3 retains the dynamic image data as a target of the process at least until the head detection unit 4 or the head tracking unit 7 completes the read process.

Head Detection Unit

The head detection unit 4 reads the image data from the dynamic image storage unit 3 to detect a head of a person from the image, and specifies head information indicating a position, a size, and the like of the detected head. The head detection unit 4 may be configured such that the head is detected by detecting the face through template matching in which a reference template corresponding to an outline of the whole face is used. The head detection unit 4 may also be configured such that a vertex such as the head is detected through a chroma-key process to detect the head based on the vertex. The head detection unit 4 may also be configured such that the head is detected by detecting a region close to a skin color as a face. The head detection unit 4 may also be configured such that learning is performed with a teacher signal through a neural network to detect a face-like region or a head-like region as the head. Additionally, the detection process performed by the head detection unit 4 may be realized by applying any already-existing technique.

User Information Storage Unit

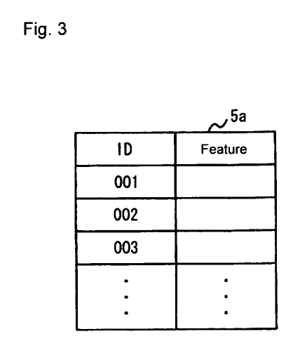

The information necessary for a face authentication process performed by the face authentication unit 6 is stored in the user information storage unit 5. FIG. 3 shows an example of a user information table 5a stored in the user information storage unit 5. The user information table 5a has a feature in the face image of each user in association with the ID of the authorized user. The feature shall mean information which is previously obtained from the face image of each user and is expressed using a brightness distribution or a color histogram.

Face Authentication Unit

Based on contents of the user information table 5a, the face authentication unit 6 determines whether or not a person detected by the head detection unit 4 is an authorized user. The face authentication unit 6 detects the face which is included in the head detected by the head detection unit 4. The face authentication unit 6 may be configured such that the face is detected by the template matching in which the reference template corresponding to the outline of the whole face is used. The face authentication unit 6 may also be configured such that the face is detected by the template matching based on face components such as eyes, a nose, and ears. The face authentication unit 6 may also be configured such that the vertex such as the head is detected through the chroma-key process to detect the face based on the vertex. The face authentication unit 6 may also be configured to detect the region close to the skin color as the face. The face authentication unit 6 may also be configured such that the learning is performed with the teacher signal through the neural network to detect the face-like region as the face. Additionally, the face detection process performed by the face authentication unit 6 may be realized by applying any already-existing technique.

Then, the face authentication unit 6 performs an authentication process to the detected face. For example, the face authentication unit 6 obtains the feature such as the brightness distribution and the color histogram from the detected face image, and judges by comparing it with the feature stored in the user information table 5a. The comparison can be performed by obtaining a normalized correlation of the brightness distribution or histogram intersection of the color histogram as a degree of similarity. When the features are determined as similar to each other, it can be determined that the person whose face image is detected is the same person, i.e., the authorized user.

Head Tracking Unit

In the dynamic image stored in the dynamic image storage unit 3, the head tracking unit 7 tracks the head including the face which is authenticated by the face authentication unit 6. That is, the head tracking unit 7 tracks the head of the user who is authenticated to be permitted to operate the monitored instrument by the face authentication unit 6. For example, the tracking process performed by the head tracking unit 7 can be realized by searching and tracking the feature point included in the head (for example, feature point at a forehead, eyebrows, eyes, ears, a nose, lips, and a head) near the feature point in a preceding frame. The tracking process can also be realized by a method of extracting an edge of the head, a method in which the brightness distribution is used, and a method in which texture information is used. The tracking process may be realized by other already-existing techniques.

Maintenance Function Control Unit

The maintenance function control unit 8 controls whether or not a maintenance function to the monitored instrument is operated based on the authentication result by the face authentication unit 6 and the tracking result by the head tracking unit 7. For example, the maintenance function control unit 8 determines whether or not a user is permitted to start/continue the operation of the monitored instrument. When the maintenance function control unit 8 determines that the user is permitted to start the operation, the maintenance function control unit 8 releases the maintenance function, operated until then, to enable the operation. When the maintenance function control unit 8 determines that the user is not permitted to continue the operation, the maintenance function control unit 8 enables the maintenance function, released until then, to disable the operation by the user. For example, the maintenance function may be realized by disabling an input device of the monitored instrument, by stopping an access to a predetermined program, data, or storage area, or by forcing the user to log off.

Then, a judgment criterion of the maintenance function control unit 8 will be described. The maintenance function control unit 8 makes the judgment with different criteria on releasing the maintenance function and on enabling the maintenance function. The maintenance function control unit 8 makes judgment on releasing the maintenance function based on the authentication result by the face authentication unit 6. That is, when the face authentication unit 6 determines that the user is qualified (user who is registered in the user information table 5a), the maintenance function control unit 8 releases the maintenance function. The maintenance function control unit 8 makes judgment on enabling the maintenance function based on the tracking result by the head tracking unit 7. That is, when the head is successfully tracked by the head tracking unit 7, the maintenance function control unit 8 continues to release the maintenance function. On the other hand, when head tracking unit 7 fails to track the head, the maintenance function control unit 8 operates and enables the maintenance function. At this point, the maintenance function control unit 8 may be configured such that the maintenance function is enabled when the head tracking unit 7 fails in the tracking process only once, or such that the maintenance function is enabled when the head tracking unit 7 fails continuously in the tracking process in the number of frames not smaller than a predetermined number or for a time not shorter than a predetermined time.

Operation Example

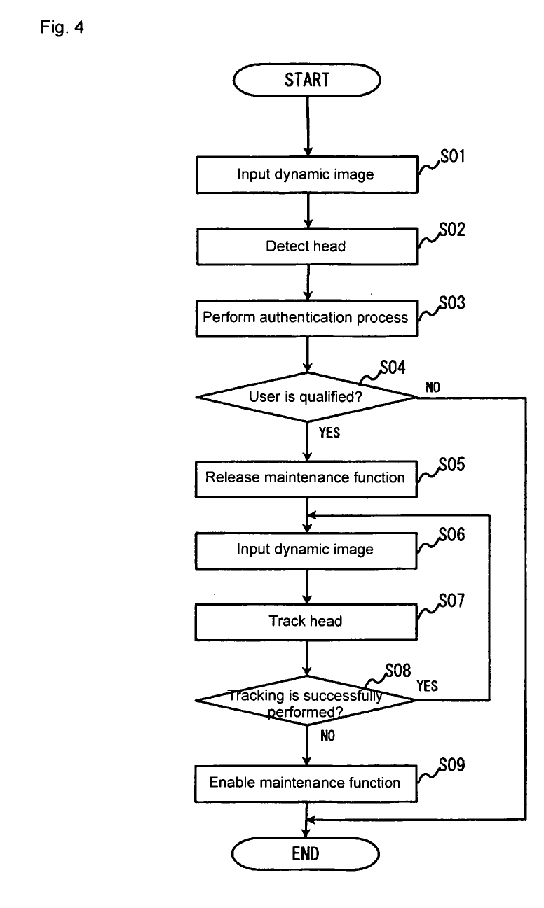

An operation example of the monitoring apparatus 1 will be now be described. FIG. 4 shows a flowchart of an operation example of the monitoring apparatus 1. The start of the operation of the monitoring apparatus 1 is triggered by the user's operation of the input device of the monitored instrument or by the user's instruction of the authentication start. When the operation is started, the dynamic image is inputted to the monitoring apparatus 1 through the image input unit 2 (S01). The inputted dynamic image data is stored in the dynamic image storage unit 3. The head detection unit 4 detects the head of the person in the dynamic image stored in the dynamic image storage unit 3 (S02). The face authentication unit 6 performs the authentication process to the face of the user detected by the head detection unit 4 (S03). When the face authentication unit 6 obtains the authentication result that the user is qualified (YES in S04), the maintenance function control unit 8 releases the maintenance function (S05) to enable the user to operate the monitored instrument. On the other hand, when the face authentication unit 6 obtains the authentication result that the user is not qualified (NO in S04), the maintenance function control unit 8 never releases the maintenance function, and the operation of the monitoring apparatus 1 is ended.

After the maintenance function is released, the new frames of the dynamic images are continuously inputted (S06), and the head tracking unit 7 tracks the head in the inputted frame (S07). When the head tracking unit 7 succeeds in tracking the head (YES in S08), the input of the new frame and the tracking of the head are continuously performed. On the other hand, when the head tracking unit 7 fails to track the head (NO in S08), the maintenance function control unit 8 enables the released maintenance function (S09) to disable the operation of the monitored instrument. The processes of S06 to S08 are repeatedly performed with a frequency of 30 frames per second, for example. However, the frequency may be appropriately changed by a manager of the monitoring apparatus 1.

Action/Effect

According to the monitoring apparatus 1 of an embodiment of the invention, the user of the monitored instrument is continuously monitored. When the user logs on, the user is monitored based on the authentication result performed by the face authentication unit 6. After the user logs on, the user is monitored based on the tracking result performed by the head tracking unit 7. While the head tracking unit 7 succeeds in tracking the user, it can be determined that the qualified user initially authenticated by the face authentication unit 6 continues the operation. Accordingly, the monitoring apparatus 1 can instantly judge the shift of the user, when the user shifts to another user.

Modification

The face authentication unit 6 may be configured such that the face authentication is periodically performed to the face of the head tracked by the head tracking unit 7.

The maintenance function control unit 8 may be configured such that operations except for the permission of the operation start/continuation to the monitored instrument are performed as the maintenance function. For example, the maintenance function control unit 8 may be configured to delete predetermined data (for example, personal information, Cookie, operation history, and access history) stored in the monitored instrument when a new user starts to use the monitored instrument. The maintenance function control unit 8 may be configured to be used in the middle of the operation, when the user who used at a previous time continuously uses the monitored instrument after the maintenance function is enabled.

In the above operation example, once the head tracking unit 7 fails to track the head, the maintenance function control unit 8 immediately enables the maintenance function. Thus, the above configuration has the highest reliability. However, sometimes the head tracking unit 7 fails to track the head although the tracking target exists in the dynamic image, when the accuracy of the tracking process is low, or when the quality of the dynamic image is poor. In the above operation example, when the head tracking unit 7 continuously fails in the tracking due to the malfunction, the maintenance function is frequently enabled, so that the operation for releasing the maintenance function possibly becomes troublesome. Therefore, when the head tracking unit 7 fails in the tracking, the head tracking unit 7 may try return (resume) of the tracking for a predetermined margin (predetermined frames or predetermined time). Specifically, even if the head tracking unit 7 fails in the tracking (NO in S08 of FIG. 4), the next frame of the dynamic image is inputted (S06), and the head as a tracking target can be searched (S07). Alternatively, when the head tracking unit 7 fails in the tracking (NO in S08), the next frame of the dynamic image is inputted (S01), the head detection and the authentication processes are performed (S02 and S03). When the face authentication unit 6 succeeds in the authentication (namely, when the user is qualified), (YES in S04), the tracking can be resumed (S07). The operability is improved by providing such margin. The margin may be a fixed value such as one time and plural times, or may be changed by the user.

What is claimed is:

1. A monitoring apparatus, comprising:
an image input unit which generates a dynamic image of a head of an operator of a monitored instrument;
an authentication device which authenticates the operator;
a tracking device which tracks the head of the operator authenticated by the authentication device in the dynamic image; and
a maintenance function control device which releases a maintenance function for the monitored instrument when the authentication device authenticates, and operates the maintenance function for the monitored instrument when the tracking device fails to track the head of the operator authenticated by the authentication device.

2. The monitoring apparatus of claim 1, wherein the authentication device detects a face in the dynamic image to authenticate the operator by using an image of the detected face, and the tracking device tracks the head as a target of the process by the authentication device.

3. The monitoring apparatus of claim 1, wherein the authentication device periodically authenticates the operator while the tracking device tracks the head of the operator in the dynamic image.

4. The monitoring apparatus of claim 1, wherein the maintenance function disables the monitored instrument.

5. The monitoring apparatus of claim 1, wherein the maintenance function restricts access to predetermined data through the monitored instrument.

6. The monitoring apparatus of claim 1, wherein the maintenance function deletes predetermined data when a new operator is authenticated.

7. The monitoring apparatus of claim 1, wherein the maintenance function control device operates the maintenance function when tracking is continuously failed in a predetermined number of frames.

8. The monitoring apparatus of claim 1, wherein the maintenance function control device operates the maintenance function when tracking is continuously failed for a predetermined period of time.

9. The monitoring apparatus of claim 2, further comprising a head detection device which detects the head of the operator prior to the authentication device detecting a face.

10. The monitoring apparatus of claim 1, further comprising a user information storage unit which stores information used to authenticate the operator of the monitored instrument.

11. The monitoring apparatus of claim 1, wherein the image input unit is a digital camera.

12. The monitoring apparatus of claim 1, wherein the monitored instrument comprises a personal computer, a PDA, or a telephone.

13. A monitoring method comprising:
authenticating an operator of a monitored instrument;
releasing a maintenance function for the monitored instrument after the operator is authenticated;
tracking a head of the authenticated operator in a dynamic image; and
operating the maintenance function for the monitored instrument if tracking the head of the authenticated operator fails.

14. The method of claim 13, wherein the operator is authenticated by detecting the operator's face in the dynamic image and comparing the operator's face to stored data.

15. The method of claim 13, wherein the maintenance function is operated when tracking is continuously failed in a predetermined number of frames.

16. The method of claim 13, wherein the maintenance function is operated when tracking is continuously failed for a predetermined period of time.

17. The method of claim 14, further comprising detecting the operator's head prior to detecting the operator's face.

18. The method of claim 13, further comprising periodically authenticating the operator while tracking the head of the authenticated operator in the dynamic image.

19. A program which causes an information processing apparatus to execute the steps of:
authenticating an operator of a monitored instrument;
releasing a maintenance function for the monitored instrument when the operator is authenticated;
tracking a head of the authenticated operator in a dynamic image in which the head of the operator of the monitored instrument is taken, when the operator is authenticated; and
operating the maintenance function for the monitored instrument when tracking fails.

20. The method of claim 19, wherein the operator is authenticated by detecting the operator's face in the dynamic image and comparing the operator's face to stored data.
